(19) United States
(12) Patent Application Publication
(10) Pub. No.: US 2009/0077472 A1
(43) Pub. Date: Mar. 19, 2009

(54) TECHNIQUES FOR DISPLAYING GRAPHICAL COMMENTS

(75) Inventor: Jeffrey Bonforte, San Francisco, CA (US)

Correspondence Address: HICKMAN PALERMO TRUONG & BECKER LLP/Yahoo! Inc., 2055 Gateway Place, Suite 550, San Jose, CA, 95110-1083, US

(73) Assignee: YAHOO! INC., Sunnyvale, CA (US)

(21) Appl. No.: 11/855,105

(22) Filed: Sep. 13, 2007

(51) Int. Cl. G06F 3/00

(52) U.S. Cl. 715/753

(57) ABSTRACT

Techniques are provided through which users can leave graphical comments on web pages associated with individual members of a social networking site. Users can do so by painting within a region on the web pages or on the web page itself. Different painting tools, such as spray paint cans and traditional paint brushes may be selected to generate different visual content on the path of paint drawn by the user. Access to paint may be restricted to members of the social networking site. Users who leave graphical comments may be charged for the graphical comments. Members may erase graphical comments on associated web pages. Graphical comments may also be generated in a chat window visible to all users engaged in a chat session.

### FIELD OF THE INVENTION

The present invention relates to displaying graphical comments.

### BACKGROUND

Social networking web sites allow users to share information about themselves and other users. Examples of social networking web sites include MySpace.com and Facebook.com. A social networking web site typically provides members of the web site with individual web pages which contain the personal profiles of the members. The personal profile web page of a member usually contains basic information about the member such as name, age, and location. The personal profile web page of a member may also contain other information such as the member's hobbies and interests, and links to the personal profile web pages of other members who are associated with the member.

One common feature of a social networking web site is providing users with the ability to leave comments for a member of the web site on that member's personal profile web page. Currently, comments are input as text and are displayed on a member's personal profile in a “flat” manner-that is, every comment is displayed the same way without distinction between the comments. Comments are also typically listed in a reverse chronological order so that the most recent comments are displayed at the top of a list of comments. While these comments may contain useful and entertaining information about the member, text comments are not visually interesting and do not convey information quickly to a user browsing a member's personal profile.

Currently, Facebook.com provides an application, “Graffiti”, which allows members to draw graphical pictures within a box that can be displayed on a member's personal profile web page. However, these pictures are displayed individually, so members cannot create a single “canvas” of graphical comments collaboratively. Furthermore, users currently may only leave graphical comments in specific regions on a web page and cannot influence the visual appearance of an entire web page. Finally, there is currently no way of generating revenues based on the generating and erasing of graphical comments.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram that illustrates an example of a personal profile web page, graphical comments, and tools for leaving graphical comments.

FIG. 2 is a diagram that illustrates an example of personal profile web page, graphical comments, and tools for erasing graphical comments.

FIG. 3 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

Techniques are provided through which users can leave graphical comments on web pages associated with individual members of a social networking site. On an individual member's web page, users use paintbrush-like tools to create graphical comments on a region in the web page which acts like a “canvas”. The “canvas” retains graphical comments from all users so that a single canvas encompasses multiple graphical comments, similar to graffiti on an urban wall.

According to one technique, the “canvas” region in the web page is rendered as a display of a “wall”, and the tools available to users are graphical drawing tools like spray paint cans, pens or paint brushes of varying colors.

According to one technique, the member with whom the web page is associated has access to tools which allow him to “erase” previous graphical comments.

According to another technique, the tools to paint graphical comments and the tools to “erase” graphical comments are provided at a cost to the user.

According to another technique, the “canvas” comprises the entire web page, so that users may leave graphical comments that affect the visual appearance of the web page.

According to one technique, users use paintbrush-like tools to leave graphical comments in a chat window in a chat session.

### Basic Operation

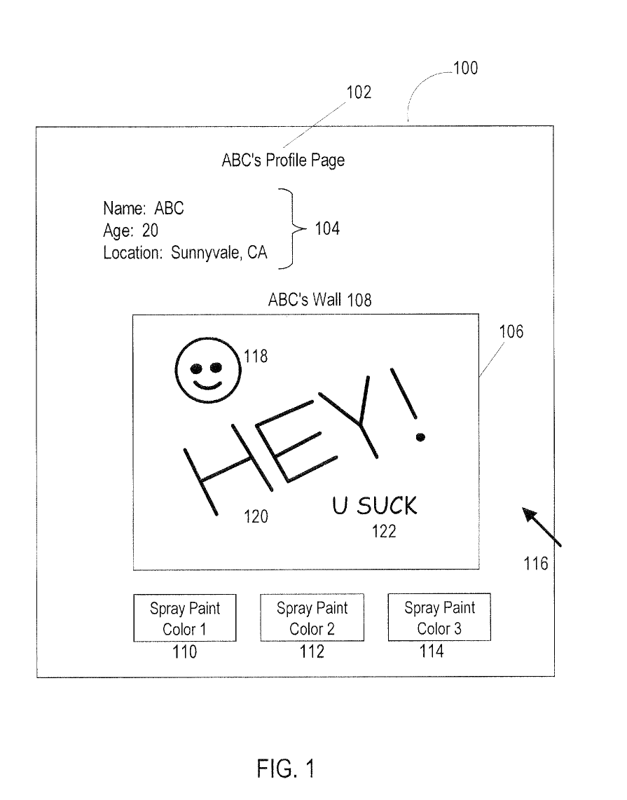

FIG. 1 is a diagram that illustrates an example of a web page on which users can leave graphical comments, according to one embodiment of the invention.

Web page 100 is a web page associated with a member of a web community. Title 102 of web page 100 indicates that web page 100 is a web page associated with member “ABC”, and contains ABC's personal profile. Web page 100 contains several elements. One element is an area that displays member ABC's basic information 104. In this example, basic information 104 includes ABC's name, age, and location.

Web page 100 also contains a region in which graphical comments can be made and displayed. In web page 100, this region is rendered as wall 106. A title 108 indicates that wall 106 is associated with member ABC. In the example in FIG. 1, wall 106 is rendered as a typical urban wall, and a user may use spray paint tools 110, 112, and 114 to “paint” on wall 106. Spray paint tools 110, 112, and 114 each allow a user to paint with a different color. One of the spray paint tools 110, 112, and 114 may be selected by moving cursor 116 over the tool and clicking on it. After a spray paint tool is selected, the user may then move cursor 116 (e.g., using a device such as a mouse and/or a trackpad) inside wall 106 to “paint” the wall with graphic comments. Paint on wall 106 is generated along the path of the movement of cursor 116 on wall 106. Graphic comments 118 (depicting a happy face), 120 (depicting large text of “HEY!”) and 122 (depicting small text of “U SUCK”) are examples of graphic comments “painted” on wall 106 with spray paint tools 110, 112, and 114.

### Graphical Variations

Although an embodiment of the invention as described above with reference to FIG. 1 includes a region for rendering graphical comments displayed as a wall and tools for rendering graphical comments available as spray paint tools, in alternative embodiments of the invention, the region may be rendered in other graphics and the tools may be any other tool for rendering graphical content.

In one alternative embodiment, the region is rendered as a photograph, which may be provided by the member.

In another alternative embodiment, the region in which graphical comments may be made and displayed comprises the entire web page. Significantly, this feature allows users to paint graphical comments that creatively affects the visual appearance of the entire web page.

### Erasing Graphical Comments

In one embodiment, a member may erase comments rendered by other users on that member's associated web page. For example, a member may be provided with tools to “paint over” graphic comments. In FIG. 1, for example, a paint-remover tool may be provided so that when a member “paints” inside the wall, graphical content along the path of the paint reverts back to the default wall graphic, thereby erasing graphical comments previously rendered along that path.

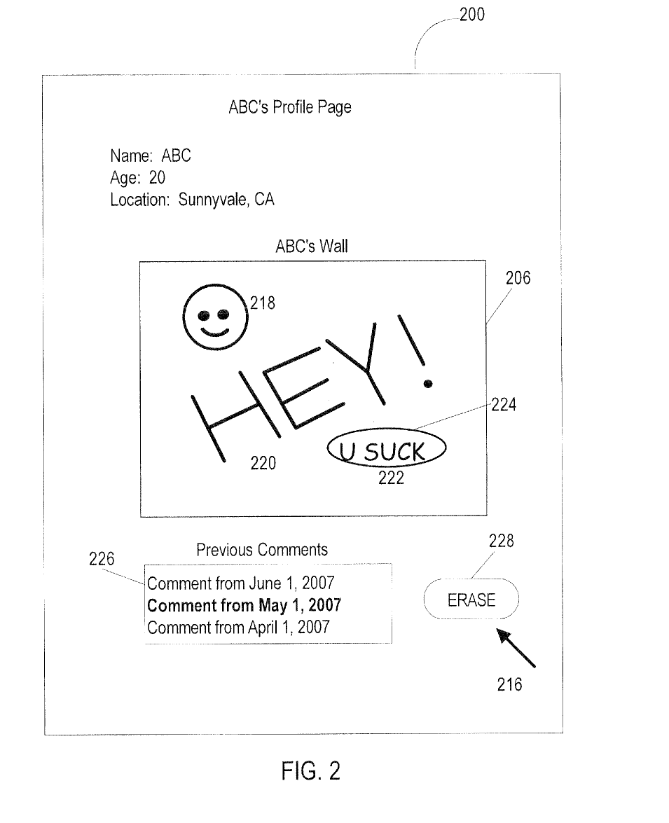

In another embodiment, a member may be provided with a list of the graphical comments made on his web page. FIG. 2 is a diagram that illustrates this embodiment. Web page 200 is a web page associated with a member of a web community. On web page 200, region 206 is where other users may leave graphical comments. Region 206 displays three graphical comments: graphical comments 218 (depicting a happy face), 220 (depicting large text of “HEY!”) and 222 (depicting small text of “U SUCK”). Web page 200 also contains list 226, which is a list of graphical comments previously rendered on region 206, listed by date. List 226 illustrates that there are three graphical comments: one rendered on Apr. 1, 2007, one rendered on May 1, 2007, and one rendered on Jun. 1, 2007. In this example, a member may move cursor 216 over the list of graphical comments displayed in list 226 and select one of them. As illustrated in FIG. 2, the graphical comment rendered on May 1, 2007 has been selected and is displayed in a bold font to indicate its selection status. At the same time, region 206 may display an indication of which of the graphical comments rendered therein corresponds to the selected graphical comment in list 226. In this example, oval 224 encircles graphical comment 222, indicating that graphical comment 222 corresponds to the selected graphical comment rendered on May 1, 2007 in list 226. A member may similarly examine other graphical comments in list 226. Once a graphical comment has been selected, a member may click on erase button 228 to remove the graphical comment from region 206. In another embodiment, a member may select a graphical comment directly in region 206 without consulting a list of graphical comments. Significantly, providing a member a way to select entire graphical comments allows the member to easily and efficiently remove an entire graphical comment without having to carefully “paint” over that comment or having to also remove previous graphical comments rendered under or close to the offending graphical comment.

### Restricted Access and Generating Revenues

In one embodiment, only users who are members of the web community are allowed to leave graphical comments on a member's web page. An initial process of authentication may be executed to verify a user's identification and membership before a user is allowed to leave a graphical comment.

In another embodiment, users are charged for leaving graphical comments on a web page. A user may be authenticated as described above to be a member of the web community, or may be authenticated as an account holder of another kind. In either case, information regarding a user's account, where the account contains an amount of credit, is gathered. When a user leaves a graphical comment, a cost may be calculated based on the tools used and the size of the comment. For example, if a user leaves a graphical comment on a “wall” using “spray paint tools”, a cost can be calculated based on how much “spray paint” is used to paint a particular graphical comment. This cost may then be deducted from the amount of credit in the user's account. If there is not enough credit in the user's account, the graphical comment may not appear on the web page. Alternatively, a user may purchase paint or other tools before rendering the graphical comment by exchanging credit in the account for an allotment of paint or other tools. The user's account may be linked to the web community so that an entity that hosts the web community will receive revenues from amounts deducted from a user's account credit for painting graphical comments on a web page in the web community.

In yet another embodiment, a member may also be charged for removing graphical comments from his web page. The member may be charged for an amount of paint remover, similar to how users are charged for an amount of paint, as described above. Alternatively, where a member can remove entire comments at once, the member can be charged on a per-comment-removed basis.

### Duration of Comments

In one embodiment, graphical comments remain in a region on the web page for only a specific duration of time. The specific duration of time can be set to a default amount of time, such as thirty days, by the community or by the owner of the personal profile web page. After the specific duration of time has elapsed after the creation of a graphical comment, the graphical comment is removed from the region.

In another embodiment, a user is charged based on the duration of the graphical comment that he has created. Graphical comments with a longer duration time cost more than graphical comments with a shorter duration time. In one example, where the cost for a graphical comment depends on both the duration time of the graphical comment and the amount of paint used for the graphical comment, a user may choose between creating a big but short-lived comment or a small but enduring comment for the same amount of money.

### Graphical Comments in a Messaging Environment

In one embodiment, users communicate with one another over the Internet via multi-user communications applications. In one example of this type of application, two users type messages to one another in a “chat window” that is shown on the displays of both users. In Yahoo!'s Instant Messenger (“IM”) application from Yahoo, Inc. in Sunnyvale, Calif., for example, two users who are both on-line at the same time may initiate a chat session, where a “chat window” is displayed on the users' display screens, allowing the users to type messages to each other. All messages typed in a particular chat session are displayed in the chat window. According to an embodiment of the invention, users may additionally or alternatively leave graphical comments in the chat window in a manner similar to leaving graphical comments on a web page, described above. For example, painting tools may be displayed in a chat window, and users may the select and use the painting tools to write message and draw in the conversation window, allowing other users in the chat session to grasp a graphical message immediately and visually.

### Hardware Overview

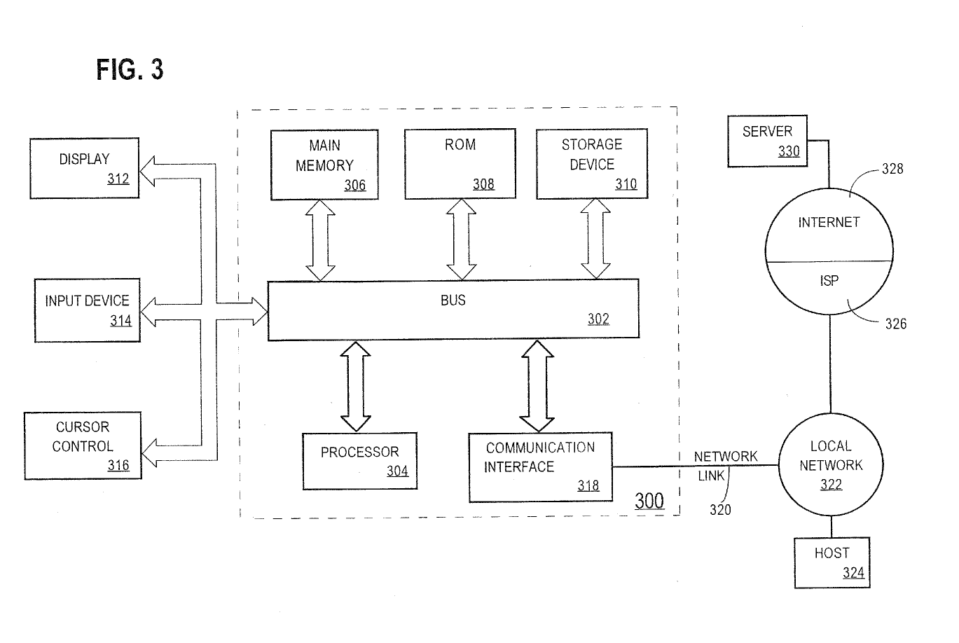

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are provided by computer system 300 in response to processor 304 executing one or more sequences of one or more instructions contained in main memory 306. Such instructions may be read into main memory 306 from another computer-readable medium, such as storage device 310. Execution of the sequences of instructions contained in main memory 306 causes processor 304 to perform the process steps described herein. One or more processors in a multi-processing arrangement may also be employed to execute the sequences of instructions contained in main memory 306. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infrared transmitter to convert the data to an infrared signal. An infrared detector coupled to bus 302 can receive the data carried in the infrared signal and place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the worldwide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

What is claimed is:

1. A method for displaying graphical comments on a webpage, comprising:
establishing a web community wherein each member of the web community is associated with an individual web page;
displaying, on a web page of a member of the web community,
(a) a region; and
(b) a plurality of tools for painting within the region,
receiving first input that indicates a first user's selection of one of the plurality of tools;
receiving second input that indicates motion of a first cursor along a first path within the region;
based on the first input and the second input, generating first visual content based on said first path within said region;
receiving third input that indicates a second user's selection of one of the plurality of tools;
receiving fourth input that indicates motion of a second cursor along a second path within the region;
based on the third input and the fourth input, generating second visual content based on said second path within said region.

2. The method of claim 1, wherein:
generating first visual content based on said first path within said region includes generating first visual content along said first path within said region; and
generating second visual content based on said second path within said region includes generating second visual content along said second path within said region.

3. The method of claim 1, wherein said first path intersects said second path.

4. The method of claim 1, further comprising:
determining whether the first user is a member of the web community;
determining whether the second user is a member of the web community;
wherein the step of generating the first visual content is performed at least in part in response to determining that the first user is a member of the web community; and
wherein the step of generating the second visual content is performed at least in part in response to determining that the second user is a member of the web community.

5. The method of claim 1, further comprising:
receiving fifth input that indicates a third user's selection of an erasure tool;
receiving sixth input that indicates motion of a third cursor along a third path within the region;
restoring to a default visual content based on said third path within said region.

6. The method of claim 1, further comprising:
associating a first identifier with the first visual content;
storing, in an index, a first entry comprising the first visual content and the associated first identifier;
associating a second identifier with the second visual content;
storing, in the index, a second entry comprising the second visual content and the associated second identifier;
wherein each entry in the index comprises a previously generated visual content and an identifier associated with the previously generated visual content;
displaying, to a member associated with the web page, a list of identifiers, wherein each identifier in the list of identifiers is associated with a visual content in the index;
receiving, from the member, a fifth input indicating a selection of one or more identifiers in the list of identifiers;
retrieving, from the index, one or more previously generated visual content associated with the one or more identifiers selected by the member;
displaying the one or more previously generated visual content in the region in a distinctive manner;
receiving, from the member, a sixth input indicating whether the member wishes to erase the one or more previously generated visual content;
in response to determining that the member wishes to erase the one or more previously generated visual content, performing the steps of:
ceasing to display the previously generated visual content in the region; and
removing, from the index, entries comprising the previously generated visual content and the one or more identifiers selected by the member.

7. The method of claim 1, wherein the plurality of tools comprises a plurality of paintbrushes with varying sizes and colors.

8. The method of claim 1, wherein the plurality of tools comprises a plurality of spray paint cans with varying sizes and colors.

9. The method of claim 1, wherein the plurality of tools comprise a plurality of shapes with varying sizes and colors.

10. The method of claim 1, wherein
the region contains a default visual content and the default visual content is a wall.

11. The method of claim 1, wherein
the region contains a default visual content and the default visual content is a picture.

12. The method of claim 1, wherein the region comprises the entire web page.

13. A method for displaying graphical comments on a webpage, comprising:
establishing a web community wherein each member of the web community is associated with an individual web page;
displaying, on a web page of a member of the web community,
(a) a region; and
(b) a plurality of tools for painting within the region;
receiving first input that indicates a user's selection of one of the plurality of tools;
receiving second input that indicates motion of a cursor along a path within the region;
calculating a cost amount based on the first input and the second input;
retrieving, from a database, information about a credit amount associated with a user from which the first and second input was received;
determining whether the credit amount is greater than the cost amount; and
in response to determining that the credit amount is greater than the cost amount, performing the steps of:
(a) deducting the cost amount from the credit amount to reach a balance amount;
(b) updating the database with the balance amount; and
(c) based on the first input and the second input, generating visual content along said path within said region.

14. The method of claim 1, further comprising:
receiving, from a user from which the first and second inputs were received, a third input that indicates a duration time;
wherein the step of calculating a cost amount comprises calculating a cost amount based on the first input, the second input, and the third input;
associating the duration time with the visual content;
removing, from the region, the visual content after an amount of time equal to the duration time associated with the visual content has elapsed.

15. A method for displaying graphical comments on a webpage, comprising:
establishing a web community wherein each member of the web community is associated with an individual web page;
displaying, on a web page of a member of the web community,
(a) a region; and
(b) a plurality of tools for painting within the region,
wherein the region comprises the entire web page;
receiving first input that indicates a user's selection of one of the plurality of tools;
receiving second input that indicates motion of a cursor along a path within the region;
based on the first input and the second input, generating visual content along said path within said region.

16. A method for displaying graphical comments, comprising:
displaying a conversation window viewable to two or more users, wherein text input received from the two or more users is displayed in the chat window;
displaying, in the conversation window, a plurality of tools for painting within the chat window;
receiving, from at least one of the two or more users, a first input that selects one of the plurality of tools;
receiving, from the at least one of the two or more users, a second input that indicates motion of a cursor along a path within the chat window; and
based on the first input and the second input, generating visual content along said path within said chat window.

17. A computer-implemented computer-readable storage medium storing instructions for displaying graphical comments on a web page, wherein the instructions include instructions which, when executed by one or more processors, cause the one or more processors to perform the steps of:
establishing a web community wherein each member of the web community is associated with an individual web page;
displaying, on a web page of a member of the web community,
(a) a region; and
(b) a plurality of tools for painting within the region,
receiving first input that indicates a first user's selection of one of the plurality of tools;
receiving second input that indicates motion of a first cursor along a first path within the region;
based on the first input and the second input, generating first visual content based on said first path within said region;
receiving third input that indicates a second user's selection of one of the plurality of tools;
receiving fourth input that indicates motion of a second cursor along a second path within the region;
based on the third input and the fourth input, generating second visual content based on said second path within said region.

18. The computer-readable storage medium of claim 1, wherein:
generating first visual content based on said first path within said region includes generating first visual content along said first path within said region; and
generating second visual content based on said second path within said region includes generating second visual content along said second path within said region.

19. The computer-readable storage medium of claim 1, wherein said first path intersects said second path.

20. The computer-readable storage medium of claim 1, wherein:
the computer-readable storage medium further comprises instructions for:
determining whether the first user is a member of the web community;
determining whether the second user is a member of the web community;
wherein the step of generating the first visual content is performed at least in part in response to determining that the first user is a member of the web community; and
wherein the step of generating the second visual content is performed at least in part in response to determining that the second user is a member of the web community.

21. The computer-readable storage medium of claim 1, wherein:
the computer-readable storage medium further comprises instructions for:
receiving fifth input that indicates a third user's selection of an erasure tool;
receiving sixth input that indicates motion of a third cursor along a third path within the region;
restoring to a default visual content based said third path within said region.

22. The computer-readable storage medium of claim 1, wherein:
the computer-readable storage medium further comprises instructions for:
associating a first identifier with the first visual content;
storing, in an index, a first entry comprising the first visual content and the associated first identifier;
associating a second identifier with the second visual content;
storing, in the index, a second entry comprising the second visual content and the associated second identifier;
wherein each entry in the index comprises a previously generated visual content and an identifier associated with the previously generated visual content;
displaying, to a member associated with the web page, a list of identifiers, wherein each identifier in the list of identifiers is associated with a visual content in the index;
receiving, from the member, a fifth input indicating a selection of one or more identifiers in the list of identifiers;
retrieving, from the index, one or more previously generated visual content associated with the one or more identifiers selected by the member;
displaying the one or more previously generated visual content in the region in a distinctive manner;
receiving, from the member, a sixth input indicating whether the member wishes to erase the one or more previously generated visual content;
in response to determining that the member wishes to erase the one or more previously generated visual content, performing the steps of:
ceasing to display the previously generated visual content in the region; and
removing, from the index, entries comprising the previously generated visual content and the one or more identifiers selected by the member.

23. The computer-readable storage medium of claim 1, wherein the plurality of tools comprises a plurality of paintbrushes with varying sizes and colors.

24. The computer-readable storage medium of claim 1, wherein the plurality of tools comprises a plurality of spray paint cans with varying sizes and colors.

25. The computer-readable storage medium of claim 1, wherein the plurality of tools comprise a plurality of shapes with varying sizes and colors.

26. The computer-readable storage medium of claim 1, wherein:
the region contains a default visual content and the default visual content is a wall.

27. The computer-readable storage medium of claim 1, wherein
the region contains a default visual content and the default visual content is a picture.

28. The computer-readable storage medium of claim 1, wherein the region comprises the entire web page.
